(19) United States
(12) Patent Application Publication
(10) Pub. No.: US 2025/0322458 A1
(43) Pub. Date: Oct. 16, 2025

(54) INFORMATION PROCESSING DEVICE, INFORMATION PROCESSING METHOD, AND COMPUTER PROGRAM

(71) Applicant: Kazuko SHOBAYASHI, Tokyo (JP)

(72) Inventor: Masayuki SHOBAYASHI, Tokyo (JP)

(73) Assignee: Kazuko SHOBAYASHI, Tokyo (JP)

(21) Appl. No.: 18/866,324

(22) PCT Filed: Jul. 12, 2023
(86) PCT No.: PCT/JP2023/025691

§ 371 Date: Nov. 15, 2024

(30) Foreign Application Priority Data
Jul. 21, 2022 (JP) 2022-116257

(51) Int. Cl. G06Q 40/06; G06F 40/279

(52) U.S. Cl. CPC G06Q 40/06; G06F 40/279

(57) ABSTRACT

The present invention provides an information processing device including: a first keyword extraction means that extracts a first keyword from a business description for a first company; a growth potential score calculation means that calculates a growth potential score for the business description on the basis of the first keyword; and an assessment means that assesses whether or not to invest in the first company on the basis of the growth potential score.

### TECHNICAL FIELD

The present invention relates to an information processing apparatus, an information processing method, and a computer program.

### BACKGROUND ART

In recent years, investments in startup companies by investing enterprises such as large corporations have become more common. In investment schemes, for example, patent rights are considered as an investment target, where the investing enterprise holds the patent rights, and when the startup company achieves growth, the patent rights are either assigned or licensed from the investing enterprise, thus enabling the recovery of the investment. In such schemes, appropriately evaluating the value of the patents is crucial for both the investing enterprise and the startup company.

Various technologies for evaluating the value of patents have been disclosed. Patent Document 1 discloses a technology that calculates the asset value of patents, based on a regression analysis of enterprises asset value and patent strength, by executing rating using the history and technical information of patent rights. Patent Document 2 discloses a technology that determines whether the scope of business of a potential licensee is covered by the patents, such that both the patent holder and the licensee can benefit.

### CITATION LIST

### Patent Document

Patent Document 1: Japanese Unexamined Patent Application, Publication No. 2017-068373

Patent Document 2: Japanese Unexamined Patent Application, Publication No. 2009-064246

### DISCLOSURE OF THE INVENTION

### Problems to be Solved by the Invention

However, financial institutions or business companies, in the case of recovering investments by assigning intellectual property rights such as patent rights, need to determine whether to invest in the acquisition of patent rights on behalf of a startup business, while considering the future growth potential of the startup business. The conventional schemes mentioned above were not able to take the growth potential of the business into account.

The present invention has been made in light of the above circumstances, and aims to appropriately evaluate the growth potential of a business.

### Means for Solving the Problems

In order to achieve the above objective, one aspect of the present invention provides an information processing apparatus that includes:
first keyword extraction unit that extracts a first keyword from the business content of a first enterprise;
growth potential score calculation unit that calculates a growth potential score for the business content, based on the first keyword; and
determination unit that determines whether to invest in the first enterprise, based on the growth potential score.

### Effects of the Invention

According to the present invention, the growth potential of a business can be appropriately evaluated.

### BRIEF DESCRIPTION OF THE DRAWINGS

FIG. 1 is a diagram illustrating an overview of the present embodiment;

FIG. 2 is a diagram illustrating a schematic configuration of the evaluation system;

FIG. 3 is a block diagram illustrating a hardware configuration of the server;

FIG. 4 is a functional block diagram illustrating an example of a functional configuration of the server;

FIG. 5 is a flowchart illustrating an example of evaluation processing;

FIG. 6 is a diagram illustrating an example of a table used in the evaluation processing;

FIG. 7 is a flowchart illustrating an example of the evaluation processing; and

FIG. 8 is a diagram illustrating an example of a table used in the evaluation processing.

### PREFERRED MODE FOR CARRYING OUT THE INVENTION

### EMBODIMENT

### Overview

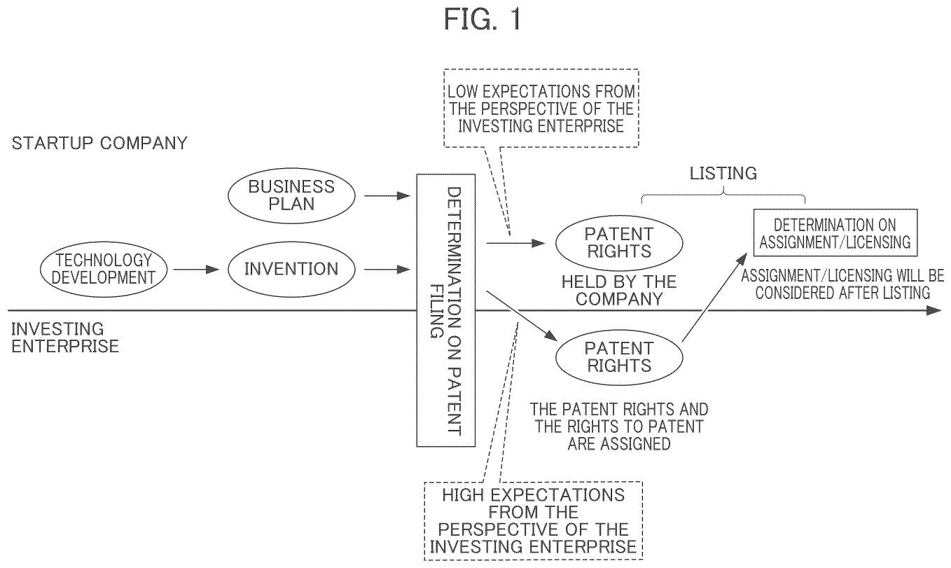

Hereinafter, the present embodiment will be described with reference to the drawings. FIG. 1 is a diagram illustrating a case example of business growth potential evaluation, to which the information processing apparatus according to the present embodiment is applied. The present embodiment describes an evaluation system that simulates the business contribution through assignment, transfer, or licensing of patent rights held by a predetermined enterprises. Specifically, the evaluation system according to the present embodiment provides support to investing enterprises in appropriately recovering investment funds when investing in startup companies.

As mentioned above, in recent years, investments in startup companies by investing enterprises such as large corporations have become more common. Through investments in startup companies, the investing enterprises seek to achieve capital gains, income gains, and business development leading to innovation. For example, in the case where a business company (investing enterprise) observes growth in the startup company and business synergy created between the investing enterprise and the startup company, the investing enterprise may consider internalizing the startup company through M&A. Usually, investments in startup companies are made through the acquisition of shares; however, acquiring shares may be challenging due to relationships with other investing enterprises. In the case where the capital strategy of the startup company changes due to the involvement of new financial backers, the intended relationship with the startup company as envisioned at the time of the investment may become difficult to maintain. In such cases, there is an investment strategy to invest in the acquisition of patent rights on behalf of the startup company. Securing patent rights at an early stage of technology development is important for startup companies in order to maintain competitiveness in the future. However, acquiring patent rights requires significant effort and cost from research and development to extraction of inventions. When filing a plurality of applications and acquiring patent rights, the maintenance cost can become substantial. Therefore, investing enterprises that invest in startup companies may act as co-applicants when acquiring patent rights and cover the maintenance cost on behalf of the startup companies at an early stage, or when participating in joint research. When the startup company grows, the investing enterprise can generate revenue by assigning the previously obtained or acquired patent rights to the startup company, thereby enabling the appropriate recovery of investment funds.

In the example illustrated in FIG. 1, the investing enterprise determines whether to acquire the patent rights on behalf of the startup company or whether the patent rights should be assigned (determination on patent filing). The investing enterprise also determines whether the owned patents should be assigned or licensed (determination on assignment/licensing).

In the present embodiment, a startup company is a newly established company that lacks sufficient financial resources and requires investment. However, the definition of a startup company is not limited to this, and any entity receiving investment may qualify, including, for example, large corporations, sole proprietors, or individuals.

An investing enterprise is a company that has sufficient financial resources and that engages in investment in startup companies, as described above. Examples of investing enterprises include large corporations, investment companies, the investment departments of banks, and corporate venture capital arms of business companies. Investing enterprises may also include professional firms (such as law firms, accounting firms, tax accountant offices, and patent firms). Investing entities are not limited to legal entities but may also include sole proprietors or individuals.

### System Configuration

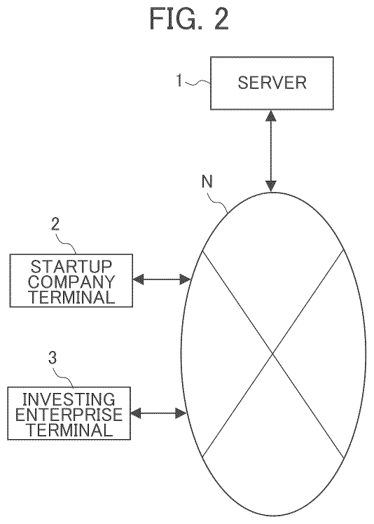

FIG. 2 is a diagram illustrating an outline of the system configuration of the evaluation system according to the present embodiment. The evaluation system of the present embodiment is configured by mutually connecting a server 1 that executes processing, a startup company terminal 2 operated by a representative of the startup company, and an investing enterprise terminal 3 operated by a representative of the investing enterprise, via a predetermined network N such as the internet. The server 1 executes various processing in cooperation with each operation of the startup company terminal 2 and the investing enterprise terminal 3.

### Hardware Configuration

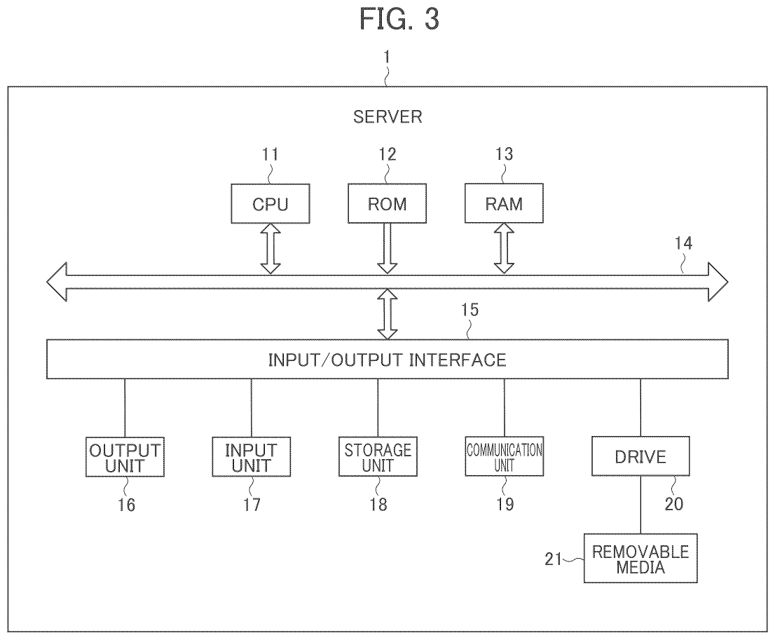

FIG. 3 is a block diagram illustrating the hardware configuration of the server 1 according to the present embodiment. The server 1 includes a CPU (Central Processing Unit) 11, a ROM (Read Only Memory) 12, a RAM (Random Access Memory) 13, a bus 14, an input/output interface 15, an output unit 16, an input unit 17, a storage unit 18, a communication unit 19, and a drive 20.

The CPU 11 executes various processing in accordance with programs stored in the ROM 12 or programs loaded into the RAM 13 from the storage unit 18. The RAM 13 also temporarily stores data necessary for the CPU 11 to execute various processing. The CPU 11, the ROM 12, and the RAM 13 are mutually connected via the bus 14. The input/output interface 15 is also connected to the bus 14.

The input/output interface 15 is connected to the output unit 16, the input unit 17, the storage unit 18, the communication unit 19, and the drive 20. The output unit 16 is composed of devices such as a display or speakers and outputs various information in the form of images or sounds. The input unit 17 is composed of devices such as a keyboard or mouse and is used to input various information. The storage unit 18 is composed of devices such as a hard disk or DRAM (Dynamic Random Access Memory) and stores various data. The communication unit 19 communicates with other devices via the network N including the internet.

Removable media 21, such as a magnetic disk, an optical disk, a magneto-optical disk, or a semiconductor memory, can be mounted to the drive 20 as appropriate. Programs read from the removable media 21 by the drive 20 can be installed into the storage unit 18 as necessary. Similar to the storage unit 18, the removable media 21 can also store various data stored in the storage unit 18.

Although not illustrated, the hardware configuration of the startup company terminal 2 and the investing enterprise terminal 3 is similar to the hardware configuration illustrated in FIG. 3.

### Functional Configuration

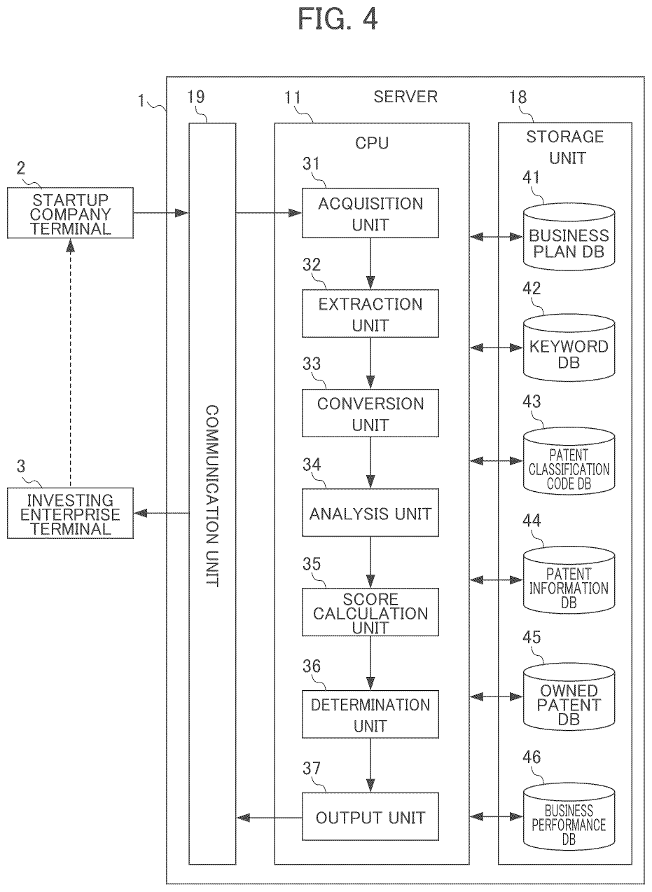

FIG. 4 is a functional block diagram illustrating an example of the functional configuration of the server 1 according to the present embodiment.

When in operation, the CPU 11 of the server 1 executes various functions, including an acquisition unit 31, an extraction unit 32, a conversion unit 33, an analysis unit 34, a score calculation unit 35, a determination unit 36, and an output unit 37.

In determination on patent filing, the acquisition unit 31 acquires business content of the startup company (first enterprise). For example, the acquisition unit 31 acquires business plan data from the startup company terminal 2. The acquired business plan is stored in the business plan DB 41. The subsequent processing may be executed using a business plan already stored in the business plan DB 41. In determination on assignment/licensing, the acquisition unit 31 acquires patent information held by the investing enterprise (second enterprise) that has invested in the startup company. For example, the acquisition unit 31 acquires the patent information stored in the owned patent DB 45. Patent information, for example, includes data on patents held by the investing enterprise. In the present embodiment, the patent information is stored in the patent information DB 44.

In determination on patent filing, the extraction unit 32 extracts business keywords (first keywords) from the business content of the startup company. The method of extracting business keywords is not particularly limited, but in the present embodiment, involves extracting words that match or are similar to keywords stored in a table in the keyword DB 42, from the words extracted by executing various natural language processing techniques. The keyword DB 42 stores trend keywords acquired by crawling or scraping webpage information from the internet, associated with predetermined business domains, and is updated as needed. In determination on assignment/licensing, the extraction unit 32 extracts technical keywords (second keywords) from the patent information. The method of extracting technical keywords is not particularly limited, but may involve extracting words related to general technologies, from the words extracted by executing various natural language processing techniques. In determination on assignment/licensing, the extraction unit 32 extracts business progress keywords (third keywords) from the business performance information of the startup company. The method of extracting business progress keywords is not particularly limited, but may involve extracting words related to general business, from the words extracted by executing various natural language processing techniques. Business performance information is information on actual performance achieved based on the business plan of the startup company.

For example, the business performance information may include annual business reports, reports to investors, IR (Investor Relations) information, and financial statements. In the case where modifications have been made to the business plan, information including the modifications is also considered business performance information. The business performance information may be acquired by the acquisition unit 31, or may use the information pre-stored in the storage unit 18 (for example, the business performance DB 46). The various extracted keywords are stored in the keyword DB 42.

In determination on patent filing, the conversion unit 33 converts the business keywords into patent classification codes. For example, the conversion unit 33 refers to the keyword DB 42 and the patent classification code DB 43 to convert the business keywords into patent classification codes. Specifically, the conversion unit 33 extracts a business domain from the business keywords, and converts the business domain into the corresponding patent classification code. The patent classification code DB 43 stores predetermined business domains, associated with patent classification codes (e.g., IPC codes) corresponding to the business domains, and is updated as needed. The conversion unit 33 may convert the business domain into a patent classification code corresponding to a word that matches or is similar to the business keyword, using a predetermined patent information search site.

In determination on patent filing, the analysis unit 34 analyzes patent applications related to the business keywords, based on the business keywords and the patent classification codes. For example, the analysis unit 34 analyzes the growth rate in number of patent applications, registration rate, citation rate, etc. of patent applications (population) related to the business keywords. The analysis unit 34 may also analyze factors other than the growth rate, registration rate, and citation rate. The growth rate indicates the rate of increase in number of patent applications related to the predetermined business domain within the population. The registration rate indicates the percentage of granted patents related to the predetermined business domain within the population. The citation rate indicates the percentage of patent documents that are cited (as prior art) by other patent documents, and relate to the predetermined business domain within the population. The patent classification codes may use, for example, IPC codes. The analysis unit 34 may, for example, search the patent database and observe the trends in number of patent applications for each IPC code (or business domain).

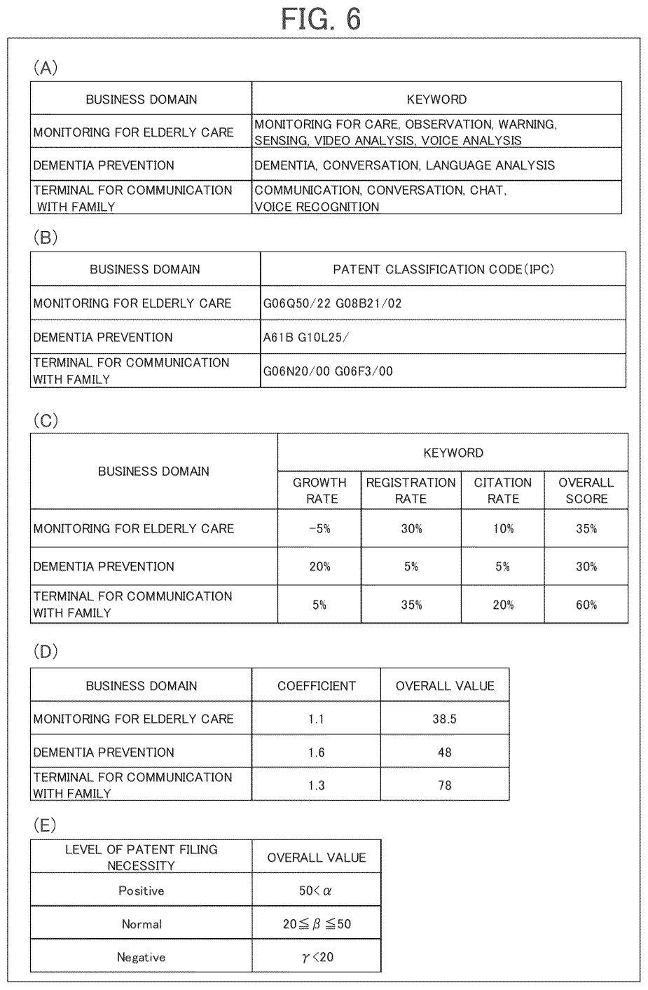

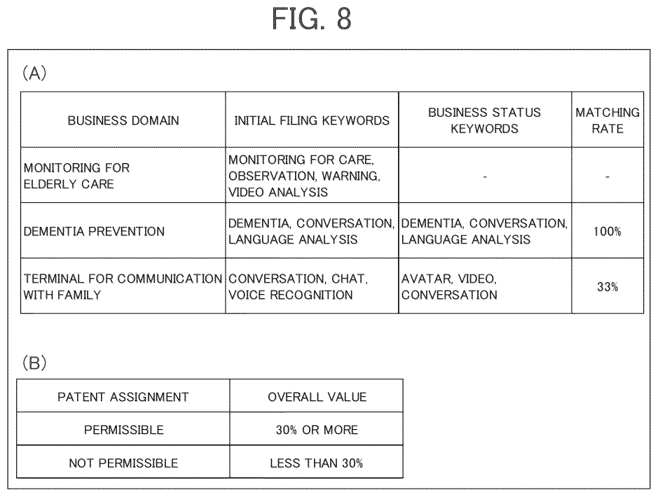

In determination on patent filing, the score calculation unit 35 calculates a growth potential score for the business content, based on the business keywords. For example, the score calculation unit 35 executes scoring using a predetermined coefficient, based on the analysis results described above (details will be described later with reference to FIGS. 6A to 6E). For example, the score calculation unit 35 may also calculate the growth potential score using classifiers (such as AI) generated by machine learning, based on the acquired business keywords. In determination on assignment/licensing, the score calculation unit 35 calculates a matching score between the technical keywords and the business progress keywords. For example, the score calculation unit 35 calculates the matching score (matching rate), based on the degree of overlap between the technical keywords and the business progress keywords for each business (details will be described later with reference to FIGS. 8A to 8B).

In determination on patent filing, the determination unit 36 determines whether to invest in the startup company (for example, whether to acquire patent rights and cover the maintenance costs on behalf of the startup company), based on the growth potential score. For example, in the case where the growth potential score is equal to or greater than a predetermined threshold, the determination unit 36 determines that investment should be made in the startup company. In determination on assignment/licensing, the determination unit 36 determines whether the patents held by the investing enterprise should be assigned or licensed. For example, in the case where the matching score exceeds a predetermined threshold, the determination unit 36 determines that the patents held by the investing enterprise should be assigned or licensed. The determination unit 36 may also determine that the patents should be licensed if the current or future business content of the investing enterprise overlaps with that of the startup company, and that the patents should be assigned if the business content does not overlap.

The output unit 37 outputs the determination results to the investing enterprise terminal 3. For example, in the case where the matching score exceeds a predetermined value, the output unit 37 outputs the corresponding patent information as an assignment candidate to the investing enterprise terminal 3.

The storage unit 18 of the server 1, as illustrated in FIG. 4, includes the business plan DB 41, the keyword DB 42, the patent classification code DB 43, the patent information DB 44, the owned patent DB 45, and the business performance DB 46.

### Processing Details

### <<Processing for Determining Patent Filing>>

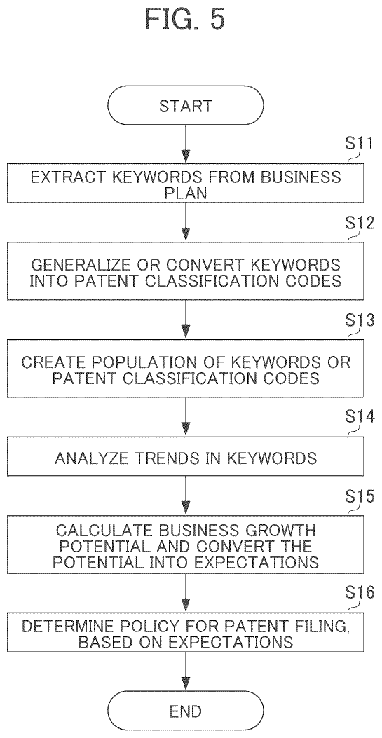

FIG. 5 is a flowchart illustrating an example of the processing for determining patent filing according to the present embodiment.

In Step S11, the extraction unit 32 extracts business keywords related to the business domain from the business plan of the startup company.

In Step S12, the conversion unit 33 converts the business keywords into patent classification codes. For example, the conversion unit 33 may convert the business keywords into patent classification codes, using a table described later.

In Step S13, the analysis unit 34 analyzes the growth rate in number of patent applications, registration rate, citation rate, etc. of the patent applications (population) related to the business keywords.

In Step S14, the analysis unit 34 searches for patent information, based on the business keywords and the patent classification codes, and analyzes the trends in patent applications related to the business keywords, based on the search results.

In Step S15, the score calculation unit 35 calculates a growth potential score (i.e., the growth potential of the business =the expectations for investment recovery), based on the analysis results.

In Step S16, the determination unit 36 determines the policy for patent filing, based on the growth potential score (expectations). For example, the determination unit 36 determines whether to acquire patent rights and cover the maintenance costs on behalf of the startup company.

FIGS. 6A to 6E illustrate an example of tables used in the processing for determining patent filing. FIG. 6A illustrates an example of a table that associates business domains (businesses) with keywords. In the present embodiment, the table as illustrated in FIG. 6A is stored in the keyword DB 42. As described above, the keywords illustrated in FIG. 6A table are trend keywords obtained by crawling or scraping webpage information on the internet, and updated as necessary. FIG. 6A illustrates an example, in which the business domains such as “monitoring for elderly care”, “dementia prevention”, and “terminal for communication with family” are extracted from the business keywords such as “monitoring”, “dementia”, and “communication”, respectively.

FIG. 6B illustrates an example of a table that associates business domains with patent classification codes. In the present embodiment, the table as illustrated in FIG. 6B is stored in the patent classification code DB 43. FIG. 6B illustrates an example, in which the patent classification codes such as “G0600/22” corresponding to the business domains are extracted.

FIG. 6C is an example of a table indicating analysis results (growth rate, registration rate, citation rate, overall score) for each business domain. FIG. 6C illustrates an example in which the growth rate, registration rate, citation rate, and overall score (total value) for each business domain are analyzed by comparing predetermined periods, based on patent documents (population) corresponding to the patent classification codes. The predetermined periods are not particularly limited, but may be, for example, the most recent five years and the preceding five years for comparison.

FIG. 6D is an example of a table indicating analysis results obtained by applying a predetermined coefficient to the analysis results (e.g., the overall score described above). The overall value as illustrated in FIG. 6D is output as the growth potential score. Here, the coefficient may be set in advance based on the importance of the business (business domain) from the perspective of the investing enterprise, or may be determined based on the number and frequency of keywords extracted during the crawling processing.

FIG. 6E illustrates an example, in which the determination results for the expectations for patent filing are indicated in three stages using predetermined thresholds. In the example illustrated in FIG. 6E, the determination results are indicated using predetermined thresholds Th1 (e.g., 50) and Th2 (e.g., 20). For example, in the case where the overall value exceeds the threshold Th1, the determination unit 36 may determine that the level of patent filing necessity is “Positive”, indicating that investment should be made. For example, in the case where the overall value is between the threshold Th1 and the threshold Th2 inclusive, the determination unit 36 may determine that the level of patent filing necessity is “Normal”, indicating that a clear decision on investment cannot be made. Furthermore, for example, in the case where the overall value is less than the threshold Th2, the determination unit 36 may determine that the level of patent filing necessity is “Negative”, indicating that investment should not be made.

### <<Processing for Determining Assignment/Licensing >>

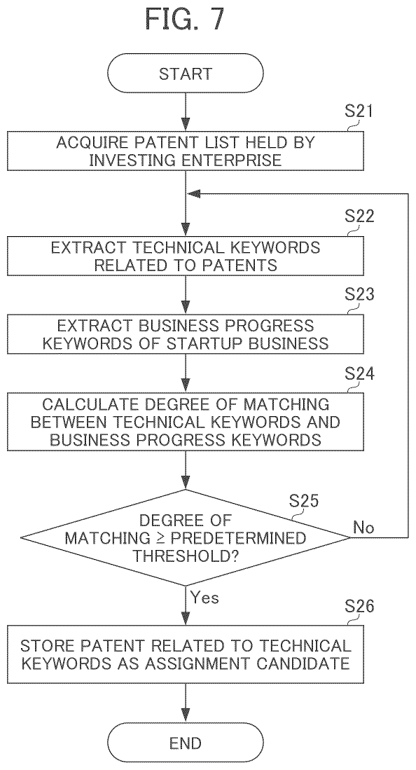

FIG. 7 is a flowchart illustrating an example of processing for determining assignment/licensing according to the present embodiment.

In Step S21, the acquisition unit 31 acquires patent information (patent list) held by the investing enterprise.

In Step S22, the extraction unit 32 extracts technical keywords related to the patents, based on the patent information.

In Step S23, the extraction unit 32 extracts business progress keywords of the startup company.

In Step S24, the score calculation unit 35 calculates the degree of matching between the technical keywords and the business progress keywords.

In Step S25, the determination unit 36 determines whether the degree of matching is equal to or greater than a predetermined threshold. If the degree of matching is equal to or greater than the predetermined threshold, the processing proceeds to Step S26; if not, the processing returns to Step S22.

In Step S26, the determination unit 36 determines that the patent held by the investing enterprise should be assigned. The determination unit 36 stores the patent related to the technical keywords as an assignment candidate in a predetermined storage unit.

FIGS. 8A and 8B illustrate an example of tables used in the processing for determining assignment/licensing. FIG. 8A illustrates an example of the technical keywords (initial filing keywords of our firm) of the investing enterprise, the business progress keywords (business status keywords) of the startup company, and the matching rates (matching scores) between these keywords in each predetermined business domain. In the example illustrated in FIG. 8A, the business progress of the startup company indicates that the business domain of “monitoring for elderly care” is not currently being pursued. In the business domain of “dementia prevention”, all keywords (three keywords) match, indicating a matching rate of 100%. Furthermore, in the business domain of “terminal for communication with family”, only one of the three keywords matches, indicating a matching rate of 33%.

FIG. 8B illustrates an example of the determination results on whether to assign a patent, presented in two stages using a predetermined threshold. In the example illustrated in FIG. 8B, the determination results are illustrated using a predetermined threshold Th3 (e.g., 30). For example, in the case where the matching degree is equal to or greater than the threshold Th3, the determination unit 36 may determine that patent assignment is “permissible”, indicating that the patent should be assigned. For example, in the case where the matching degree is less than the threshold Th3, the determination unit 36 may determine that patent assignment is “not permissible”, indicating that the patent should not be assigned.

### Advantageous Effects of Present Embodiment

According to the above-described embodiment, the growth potential of the business of the startup company can be appropriately evaluated.

According to the above-described embodiment, the startup company, even in a state of uncertain business content, can actively pursue patents (or file patent applications) for its technology without bearing the financial burden. This provides an effect comparable to that of traditionally practiced stock assignment, but unlike stock assignment, the startup company can receive support from the investing enterprise without being influenced by the management policy of the investing enterprise.

According to the above-described embodiment, the investing enterprise can negotiate favorably with the startup company when the startup company achieves growth, in exchange for having covered the filing costs on behalf of the startup company. While one embodiment of the present invention has been described above, the present invention is not limited to the above-described embodiment, and modifications, improvements, and the like that achieve the objectives of the present invention are included within the scope of the present invention.

### MODIFICATION EXAMPLE

In the above-described embodiment, an example has been described, in which determinations are made on both patent filing and assignment/licensing; however, this is not limiting, and only one of these determinations may be made.

In the above embodiment, an example has been described, in which the investing enterprise and the startup company are each a single enterprise, but one or both may consist of a plurality of enterprises. For example, it is conceivable that a plurality of enterprises may act as investing enterprises to support a startup company, or one investing enterprise may support a plurality of startup companies.

In the above-described embodiment, an example of patent filing and assignment/licensing has been described; however, the invention is not limited thereto, and other intellectual property rights, such as utility model rights, trademark rights, or design rights, or combinations thereof, may also be targeted. In addition to patent rights, the value of the combination of data, software, or copyrighted works held by the enterprise may be determined, assigned, or licensed.

### OTHERS

For example, the series of processing described above can be executed by hardware or by software. In other words, the functional configuration described above is merely an example and is not limited in particular. That is, as long as the information processing system is provided with the function to execute the series of processing as a whole, the specific functional blocks used to achieve this function are not restricted to the above examples. The location of the functional blocks is also not limited in particular and may be optional. For example, the functional blocks of the server may be transferred to other devices. Conversely, the functional blocks of other devices may be transferred to the server. A single functional block may be composed of hardware alone, software alone, or a combination thereof.

When the series of processing is executed by software, the program constituting the software is installed on the computer from a network or recording medium. The computer may be a computer embedded in dedicated hardware. Alternatively, the computer may be a computer, such as a server, and a general-purpose smartphone or personal computer, capable of executing various functions by installing various programs.

The recording medium containing such programs is not limited to removable media, which are distributed separately from the device body in order to provide the programs to users, but may also include recording media provided to users where the programs are pre-installed in the device body. Since the programs can be distributed via a network, the recording medium may be installed on or accessible to a computer connected or connectable to the network.

In this specification, the steps for describing the program recorded on the recording medium include not only the processing executed chronologically in sequence, but also the processing executed in parallel or individually, even if not chronologically. In this specification, the term “system” refers to an overall apparatus composed of a plurality of devices or means.

In other words, the information processing apparatus, to which the present invention is applied, can take various embodiments including the following configurations:
(1) An information processing apparatus including: first keyword extraction unit (extraction unit 32) that extracts a first keyword from the business content of a first enterprise; growth potential score calculation unit (score calculation unit 35) that calculates a growth potential score for the business content, based on the first keyword; and determination unit (determination unit 36) that determines whether to invest in the first enterprise, based on the growth potential score.
(2) The apparatus may further include conversion unit (conversion unit 33) that converts the first keyword into a patent classification code, and analysis unit (analysis unit 34) that analyzes patent applications related to the patent classification code, in which the growth potential score calculation unit may calculate the growth potential score for the business content, based on the analysis results by the analysis unit.
(3) The analysis unit may calculate at least one of a growth rate in number of applications, a registration rate, or a citation rate for the patent applications related to the first keyword.
(4) The apparatus may further include: patent information acquisition unit (acquisition unit 31) that acquires patent information held by a second enterprise that has invested in the first enterprise; second keyword extraction unit (extraction unit 32) that extracts a second keyword from the patent information; third keyword extraction unit (extraction unit 32) that extracts a third keyword from the business performance information of the first enterprise; matching score calculation unit (score calculation unit 35) that calculates a matching score between the second keyword and the third keyword; and output unit (output unit 37) that outputs the corresponding patent information as an assignment candidate in the case where the matching score is greater than a predetermined value.
(5) The matching score calculation unit may calculate the matching score, based on the degree of overlap between the second keyword and the third keyword for each predetermined business domain.
One aspect of the present invention is (6) a method of controlling an information processing apparatus, in which a computer executes: a first keyword extracting step of extracting a first keyword from the business content of a first enterprise; a growth potential score calculating step of calculating a growth potential score for the business content, based on the first keyword; and a determining step of determining whether to invest in the first enterprise, based on the growth potential score.
One aspect of the present invention is (7) a computer program that causes a computer to execute: a first keyword extracting step of extracting a first keyword from the business content of a first enterprise; a growth potential score calculating step of calculating a growth potential score for the business content, based on the first keyword; and a determining step of determining whether to invest in the first enterprise, based on the growth potential score.

### EXPLANATION OF REFERENCE NUMERALS

1: server
2: startup company terminal
3: investing enterprise terminal
11: CPU
18: storage unit
19: communication unit
31: acquisition unit
32: extraction unit
33: conversion unit
34: analysis unit
35: score calculation unit
36: determination unit
37: output unit
41: business plan DB
42: keyword DB
43: patent classification code DB
44: patent information DB
45: owned patent DB
46: business performance DB

1. An information processing apparatus, comprising:
a first keyword extraction unit that extracts a first keyword from business content of a first enterprise;
a growth potential score calculation unit that calculates a growth potential score for the business content, based on the first keyword; and
a determination unit that determines whether to invest in the first enterprise, based on the growth potential score.

2. The information processing apparatus according to claim 1, further comprising:
a conversion unit that converts the first keyword into a patent classification code; and
an analysis unit that analyzes a patent application related to the patent classification code, wherein
the growth potential score calculation unit calculates the growth potential score for the business content, based on a result of analysis by the analysis unit.

3. The information processing apparatus according to claim 2, wherein the analysis unit calculates at least one of a growth rate in number of applications, a registration rate, or a citation rate for patent applications related to the first keyword.

4. The information processing apparatus according to claim 1, further comprising:
a patent information acquisition unit that acquires patent information held by a second enterprise that has invested in the first enterprise;
a second keyword extraction unit that extracts a second keyword from the patent information;
a third keyword extraction unit that extracts a third keyword from business performance information of the first enterprise;
a matching score calculation unit that calculates a matching score between the second keyword and the third keyword; and
an output unit that outputs corresponding patent information as an assignment candidate in a case where the matching score is greater than a predetermined value.

5. The information processing apparatus according to claim 4, wherein the matching score calculation unit calculates the matching score, based on a degree of overlap between the second keyword and the third keyword for each predetermined business domain.

6. A method of controlling an information processing apparatus, the method causing a computer to execute:
a first keyword extracting step of extracting a first keyword from business content of a first enterprise;
a growth potential score calculating step of calculating a growth potential score for the business content, based on the first keyword; and
a determining step of determining whether to invest in the first enterprise, based on the growth potential score.

7. A non-transitory computer readable medium storing computer program that causes a computer to execute:
a first keyword extracting step of extracting a first keyword from business content of a first enterprise;
a growth potential score calculating step of calculating a growth potential score for the business content, based on the first keyword; and
a determining step of determining whether to invest in the first enterprise, based on the growth potential score.
